(19) United States
(12) Patent Application Publication
(10) Pub. No.: US 2004/0268359 A1
(43) Pub. Date: Dec. 30, 2004

(54) Computer-readable medium, method and computer system for processing input/output requests

(76) Inventor: David H. Hanes, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/609,395

(22) Filed: Jun. 27, 2003

(51) Int. Cl. G06F 3/00

(52) U.S. Cl. 719/310

(57) ABSTRACT

A computer-readable medium having stored thereon an instruction set to be executed, the instruction set, when executed by a processor, causes the processor to perform a computer method of receiving an input/output request formatted in accordance with an application programming interface, generating an input/output request formatted in accordance with an adapter interface layer, and submitting the generated input/output request to the adapter interface layer is provided. A method for processing an input/output request in a computer system comprising receiving, by a translation layer comprising a set of computer-readable instructions, an input/output request formatted in accordance with an application programming interface and generating, by the translation layer, an input/output request in a format compatible with an adapter interface layer of an operating system is provided. The generated input/output request is submitted to the adapter interface layer.

### TECHNICAL FIELD OF THE INVENTION

This invention relates to computer technologies and, more particularly, to a computer-readable medium, method, and system for processing input/output requests.

### BACKGROUND OF THE INVENTION

Computer systems typically comprise a motherboard having various sockets, or expansion host interfaces, that facilitate connection of one or more peripheral devices therewith. A daughter-board, or host adapter, is inserted into the host interface and a peripheral device may be connected with the daughter-board. A host interface may have a standardized protocol through which computer system devices and/or applications may communicate with the peripheral device. The well-known integrated drive electronics (IDE) interface and the small computer system interface (SCSI) are two examples of standardized, system-level interfaces for communications between a computer and a peripheral device.

A device driver is responsible for accessing peripheral device registers and forms part of the lowest-level of a computer operating system. An application may communicate with a peripheral device by interfacing with the device driver. An application programming interface (API) may be utilized to greatly simplify application development by allowing a programmer to interface with a device driver via high-level program function calls.

### SUMMARY OF THE INVENTION

Heretofore, a technique has not been available for allowing a computer system to process an input/output request issued by an application formatted in accordance with an application programming interface not supported by the computer system.

In accordance with an embodiment of the present invention, a computer-readable medium having stored thereon an instruction set to be executed, the instruction set, when executed by a processor, causes the processor to perform a computer method of receiving an input/output request formatted in accordance with an application programming interface, generating an input/output request formatted in accordance with an adapter interface layer, and submitting the generated input/output request to the adapter interface layer is provided.

In accordance with another embodiment of the present invention, a method for processing an input/output request in a computer system comprising receiving, by a translation layer comprising a set of computer-readable instructions, an input/output request formatted in accordance with an application programming interface and generating, by the translation layer, an input/output request in a format compatible with an adapter interface layer of an operating system is provided. The generated input/output request is submitted to the adapter interface layer.

In accordance with yet another embodiment of the present invention, a computer system for processing an input/output request comprising a processing element, a host adapter, and a local interface communicatively coupling the processing element and the host adapter, the processing element operable to execute a set of computer-readable instructions operable to receive an input/output request formatted in accordance with an application programming interface and generate an input/output request formatted in accordance with an adapter interface layer of an operating system is provided. The generated input/output request is dependent upon the received input/output request and is submitted to the adapter interface layer.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified schematic illustrative of an advanced SCSI programming interface as may be conventionally implemented;

FIG. 2 is a block diagram of a computer-readable instruction set having an adapter service translation layer according to embodiments of the present invention;

FIG. 3 is a block diagram of a translation layer interfacing with a client application and an adapter interface layer according to embodiments of the invention; and

FIG. 4 is a block diagram of a computer system comprising a translation layer that facilitates communications with a peripheral device according to embodiments of the present invention.

### DETAILED DESCRIPTION OF THE DRAWINGS

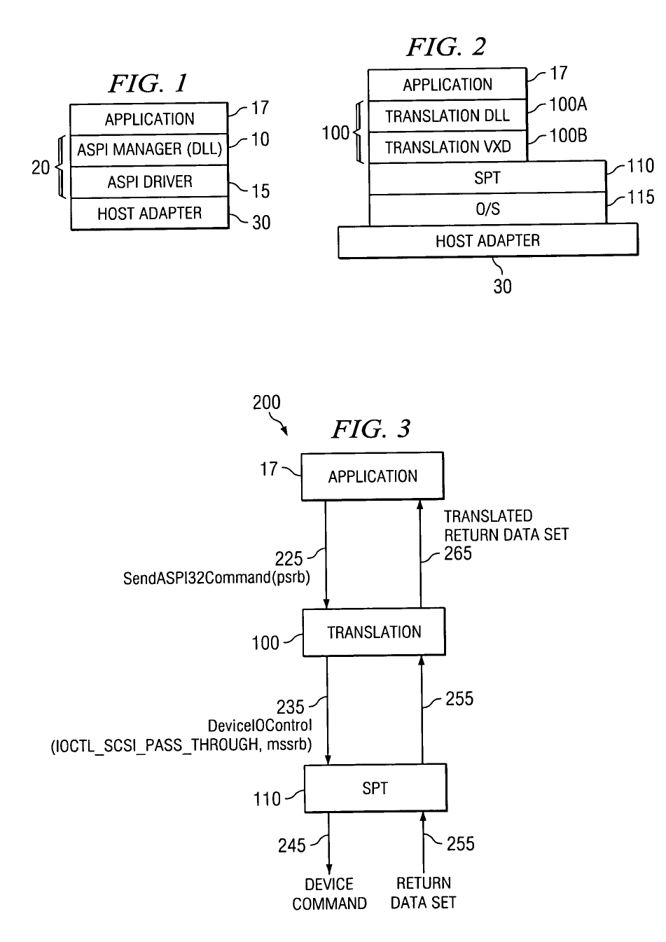

The preferred embodiment of the present invention and its advantages are best understood by referring to FIGS. 1 through 4 of the drawings, like numerals being used for like and corresponding parts of the various drawings.

Many software applications are required to communicate with a peripheral device of a computer system. A device driver is specialized software that controls a hardware component of a peripheral device. A device driver may be responsible for accessing a hardware register(s) of the peripheral device and may include an interrupt handler to process hardware interrupts generated by the peripheral device. The device driver may be implemented as a low-level portion of an operating system (O/S) kernel. Alternatively, the device driver may be implemented as a file(s) loaded after system boot. Additionally, a virtual device driver may facilitate execution of I/O requests issued by a client application and directed toward the peripheral device. A virtual device driver is generally operable to maintain status metrics of dynamic settings of the peripheral device and handles software interrupts generated by the O/S during communications with the peripheral device. A collection of subroutines and functions, e.g. a dynamically linked library (DLL), may be logically linked to the client application and enables sharing of functions among multiple tasks. The DLL may encompass the device driver, or a portion thereof, and is typically maintained in a storage device, such as a disk drive, until called by the client application.

The lack of a standard technique for communications between various client applications and numerous peripheral devices of a computer system necessitates development of various drivers. That is, in the absence of a high level interface for communicating with the peripheral device via the computer O/S, specialized driver software must be developed to coordinate communications between each client application and any peripheral device that the client application communicates with. Coding of various device drivers is a time consuming task that requires specialized skill sets of software developers and greatly increases the time and cost of application development. Accordingly, specialized interfacing software has been developed that provides a high level application programming interface (API) accessible by various client applications that facilitates communications with one or more peripheral devices.

An exemplary API that provides high-level interfacing of a client application with a peripheral device is the advanced SCSI programming interface (ASPI) developed by ADAPTEC. ASPI provides a standard interface that facilitates communications between an application and a peripheral device or peripheral device driver. ASPI greatly simplifies development of applications that may require communication with a SCSI device, an IDE device, or another peripheral device.

In general, an API may be implemented that exploits various commonalties among different hardware devices manufactured by various vendors that share a common standardized hardware interface. For example, numerous vendors may develop SCSI adapters for interfacing with SCSI hard drives, CD drives, DVD drives, and other peripheral devices manufactured according to SCSI standards. Although different SCSI adapters may have distinguishing hardware characteristics due to proprietary development techniques and features, each of the adapters share a common set of interface characteristics pursuant to being compatible with the SCSI standard. Thus, an application programming interface handles common communication requirements and provides a standardized, high-level interface to various devices sharing a common system-level interface.

FIG. 1 is a simplified schematic illustrative of an ASPI layer 20 as may be conventionally implemented. An ASPI manager 10 provides a service layer for managing and processing ASPI requests received from, for example, an ASPI client application 17. ASPI manager 10 may be implemented as a DLL file, e.g., wnaspi32.dll. An ASPI driver 15 may be implemented as a virtual device driver and passes access requests to one or more host adapters 30 and conveys retrieved information, for example a return value data set(s) resulting from an executed input/output (I/O) request, to ASPI manager 10. ASPI driver 15 may interface with a SCSI bus and, by utilizing the protocols of ASPI manager 10, commands may be sent to a SCSI host adapter 30 via ASPI manager 10. Accordingly, various peripheral devices 30 manufactured by different vendors and featuring various proprietary technologies unique thereto may have applications and drivers written therefor that commonly conform to the ASPI standard and that are independent of the particular host adapter 30.

ASPI was originally developed to allow access to SCSI and integrated drive electronics (IDE) devices directly by an operating system, e.g., DOS, WINDOWS 95, WINDOWS 98, OS/2, NETWARE and other operating systems, that otherwise lacks such interfacing capabilities. The extent of the popularity of ASPI resulted in various operating system vendors including ASPI in operating system installation packs. However, more recent operating systems, for example WINDOWS 2000, WINDOWS NT, and WINDOWS XP, do not include ASPI for various reasons. For example, ASPI allows access violations of various operating system protocols. WINDOWS NT, for example, provides assignment of access privileges that may be used to restrict access requests to members assigned a particular access right. ASPI requests may be issued that violate the WINDOWS NT security model and allow unauthorized users to execute otherwise restricted access requests. As a result, various software applications and drivers developed for operating system versions that included an ASPI layer are inoperable on newer operating systems that do not include the ASPI layer. Accordingly, an application and/or driver developed according to the ASPI protocol must be re-developed for execution on a computer system that does not feature ASPI or, alternatively, a user must obtain and install ASPI on the computer system. In the later case, violation of operating system security features remains problematic.

FIG. 2 is a block diagram of a computer-readable instruction set having an adapter service translation layer 100 according to embodiments of the present invention. Translation layer 100 may service ASPI requests on a computer system or other computational device that does not feature an ASPI layer and in a manner that avoids security model violations of various operating systems. An operating system 115, e.g., WINDOWS 2000, comprises an adapter interface layer 110 that may receive and process adapter I/O requests. As used herein, an adapter interface layer refers to an application or a set of computer-executable instructions that enables another application or program access to a peripheral device. Preferably, adapter interface layer 110 is implemented as a pass-through interface although other implementations are possible. Typically, a pass-through interface provides different instruction sets that may be selected by an application for communicating, or otherwise interacting, with different peripheral devices. In the exemplary embodiment, adapter interface layer 110 comprises a SCSI pass-through (SPT) interface that is included in various WINDOWS operating system installations. However, the present invention is not limited to implementation on a particular operating system or pass-through interface. For example, embodiments of the invention may be implemented on a computer system having a UNIX operating system and a storage driver interface (SDI) pass-through interface. Adapter interface layer 110 accepts SCSI I/O requests formatted according to a standardized adapter interface format, e.g., in accordance with an SPT protocol. Adapter service translation layer 100 may comprise a DLL translation layer 100A and/or a virtual device driver translation layer 100B. Translation layer 100 provides an interface for application 17, such as an ASPI client program, an ASPI driver, or another hardware and/or software device operable to generate an I/O request formatted in accordance with an API protocol and directed to host adapter 30. For example, translation layer 100 may receive an I/O request formatted according to the ASPI protocol and derive or otherwise generate an I/O request therefrom that is formatted in accordance with adapter interface layer 110, e.g., SPT format. Adapter interface layer 110, in turn, processes and issues the translated I/O request to host adapter 30. Likewise, translation layer 100 operates to translate return values received by adapter interface layer 110 and formatted in accordance therewith into a format suitable for ASPI application 17.

The invention may better be understood with reference to block diagram 200 of translation layer 100 interfacing with client application 17 and adapter interface layer 110 in FIG. 3. In general, an ASPI-formatted I/O request 225 is made by submitting a function call for SendASPI32Command in accordance with the following function prototype:

DWORD SendASPI32Command (LPSRB)

where LPSRB is a pointer to a SCSI request block (SRB) formatted as described below. A request block comprises a data structure for issuing commands to a peripheral device. Particularly, a request block comprises members or fields that respectively comprise a value defining a parameter or characteristic of the I/O request necessary for proper execution of the I/O request. A command code of the SRB is used to specify the type of I/O request, e.g., SC_HA_INQUIRY, SC_EXEC_SCSI_CMD, etc. An ASPI-formatted SRB is well documented and a detailed description thereof is described in “ASPI for Win32” by ADAPTEC and is briefly described below.

In accordance with embodiments of the invention and to facilitate processing of I/O request 225 formatted and issued in accordance with an API unavailable on the computer system, translation layer 100 receives I/O request 225 and translates the ASPI formatted I/O request 225 into a format suitable for processing by adapter interface layer 110. An SRB referenced by an argument of ASPI I/O request 225 will generally conform to the following ASPI SRB structure definition:

typedef struct ASPI_SRB{

| | |
|---|---|
| BYTE | SRB_Cmd; |
| BYTE | SRB_Status; |
| BYTE | SRB_HaId; |
| . | |
| . | |
| . | |
| BYTE | SRB_Target; |
| BYTE | SRB_Lun; |
| DWORD | SRB_BufLen; |
| BYTE | *SRB_BufPointer; |
| BYTE | SRB_SenseLen; |
| BYTE | SRB_CDBLen; |
| . | |
| . | |
| } | |

In the present example, assume a structure psrb is declared as type ASPI_SRB and the ASPI I/O request 225 is issued by client application 17 by calling a SendASPI32Command function with a pointer or other reference to the psrb structure as an argument of the function call. Further assume the member SRB_cmd of psrb is set to SC_EXEC_SCSI_CMD to define the request as an execute SCSI I/O command. Various psrb members further define the particular I/O request characteristics or parameters. For example, a SRB_HaId member identifies the particular host adapter to which the I/O requested is to be directed. SRB_Target and SRB_Lun members respectively identify the particular target device and a logical unit number to which the I/O request is directed. An SRB_BuLen member defines the size of the buffer subject to the I/O request and the pointer *SRB_BufPointer provides a reference to a buffer location to be addressed by the I/O request. SRB_SenseLen defines the length of the sense buffer in bytes. The SRB_CDBLen member defines the command descriptor block length. The source code for the above described ASPI-formatted SRB structure definition is illustrative of a portion of an ASPI-formatted SRB structure. Other SRB members are typically included in an ASPI-formatted SRB structure as necessary to fully define I/O request 225. The SRB members described are chosen only to facilitate an understanding of the invention.

ASPI I/O request 225 is received by translation layer 100 and an I/O request 235 formatted in accordance with adapter interface layer 110, e.g., SPT, is derived therefrom. An exemplary SRB structure suitable for processing by adapter interface layer 110 comprising a SCSI pass-through layer is generally declared as a SCSI_PASS_THROUGH type according to the type definition as follows:

```
typedef struct SCSI_PASS_THROUGH {
      .
      .
UCHAR  TargetId;
UCHAR  Lun;
UCHAR  CdbLength;
UCHAR  SenseInfoLength;
      .
      .
      .
ULONG  DataTransferLength;
```

}

For illustrative purposes, assume a pointer mssrb is declared as type SCSI_PASS_THROUGH. An SRB structure referenced by pointer mssrb is used in conjunction with a function call to issue an I/O command to the target device. In accordance with the illustrative example, SPT-formatted I/O request 235 comprises a function call to DeviceIOControl and includes a function argument IOCTL_SCSI_PASS_THROUGH as a control code for I/O request 235. Additionally, pointer mssrb points to the SRB required for executing the command defined by I/O request 235. In the present example, the TargetId member identifies the device to which the I/O request is directed and the Lun member identifies the particular logical unit number of the target device. The CdbLength member defines the command descriptor block length. The SenseInfoLength member identifies the length of the sense buffer in bytes. The DataTransferLength member defines the size of the buffer subject to the I/O request. The exemplary SCSI_PASS_THROUGH structure is illustrative of a portion of a source code used for defining a suitable SPT-formatted SRB structure for processing of an I/O request by adapter interface layer 110. Other members of the SCSI_PASS_THROUGH structure are typically required for processing a SCSI I/O request as is understood by those skilled in the art. The structure members shown and described are chosen to facilitate an understanding of the invention. Moreover, while the DeviceIOControl function is shown as including two arguments (IOCTL_SCSI_PASS_THROUGH and mssrb), it should be understood that other function arguments may be required for proper processing of I/O request 235. For example, an argument specifying the size of the input buffer, an argument specifying the output buffer that is to receive the data returned by processing of 10 request 235, or other arguments may be required for proper execution of I/O request 235.

Preferably, translation layer 100 receives ASPI-formatted SCSI I/O request 225 and identifies an I/O request type. For example, translation layer 100 may parse the SRB_Cmd member from the psrb data structure and evaluate the I/O request type from the command code. After identification of the I/O request type, translation layer derives, retrieves, or otherwise generates a corresponding I/O request formatted for adapter interface layer 110 from contents of the psrb structure. Generated I/O request 235 comprises an adapter interface layer command type that corresponds to the API command type of received I/O request 225. In the present example, translation layer 100 assigns an adapter interface layer command type to I/O request 235 by including a control code, e.g., IOCTL_SCSI_PASS_THROUGH, corresponding to the identified ASPI command type (identified by member SRB_cmd) as an argument of I/O request 235. However, other techniques for assignment of a command type to generated I/O request 235 may be implemented. For example, a member of an SRB referenced by generated I/O request 235 may have a value assigned thereto that corresponds to the identified command type. Alternatively, generated I/O request 235 may comprise a function call that corresponds to the identified command type. Regardless of the particular implementation, translation layer 100 is preferably adapted to generate I/O request 235 that has a command type corresponding to the particular command type of ASPI formatted I/O request 225. Moreover, it is preferred that translation layer 100 is operable to identify all possible application programming interface-formatted command types and issue I/O requests corresponding thereto such that generated I/O request 235 is dependent on received I/O request 225. In an exemplary embodiment, translation layer 100 parses members from the ASPI_SRB structure referenced by the argument psrb of ASPI I/O request 225 and generates an adapter interface layer-formatted I/O request 235 suitable for processing by adapter interface layer 110. An exemplary portion of translation source code used for implementing translation layer 100 in accordance with an embodiment of the invention is provided below for parsing ASPI formatted I/O request 225, or an SRB referenced thereby, and for producing I/O request 235 formatted in accordance with adapter interface layer 110:

101 mssrb->TargetId=psrb->SRB_Target;

102 mssrb->Lun=psrb->SRB_Lun

103 mssrb->CdbLength=psrb->SRB_CDBLen

104 mssrb->SenseInfoLength=psrb->SRB_SenseLen

105 mssrb->DataTransferLength=psrb->SRB_BufLen

.

.

.

The mssrb structure generated by translation layer 100 comprises an SRB formatted in accordance with the adapter interface layer 110 and generally conforms to the SCSI_PASS_THROUGH structure described above. Accordingly, a TargetId member and a Lun member of the mssrb are respectively assigned the value of the SRB_Target member and the SRB_Lun members parsed from psrb (lines 101 and 102). A CdbLength member of the mssrb is assigned a value of the SRB_CDBLen member parsed from the psrb structure (line 103). Likewise, the SenseInfoLength and the DataTransferLength members are respectively assigned values of the SRB_SenseLen and SRB_BufLen members parsed from the psrb (lines 104 and 105).

By parsing various member values from the psrb structure referenced by ASPI formatted I/O request 225 and writing the values to appropriate members of the mssrb structure formatted in accordance with adapter interface layer 110, I/O request 235 conforms to interface layer 110 and may be executed thereby.

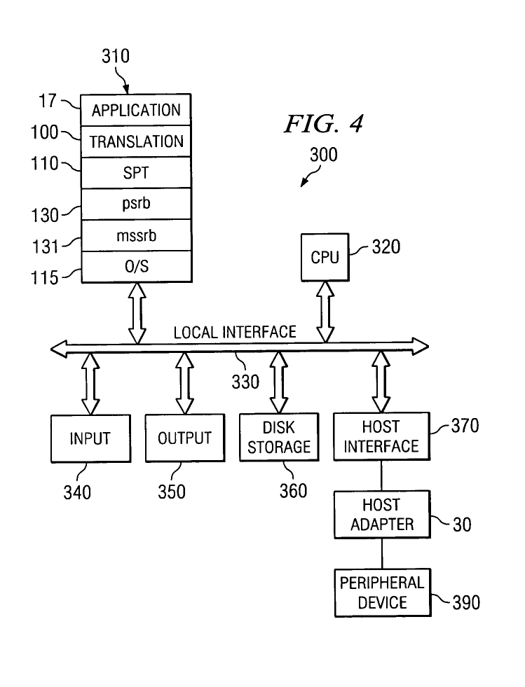

FIG. 4 is a block diagram of a computer system 300 that comprises translation layer 100 implemented as a software application that facilitates communications with peripheral device(s) 390 according to embodiments of the present invention. Computer system 300 stores application 17 in a memory unit 310. Through conventional techniques, application 17 is executed by an operating system (O/S) 115 and one or more conventional processing elements 320 such as a central processing unit. Operating system 115 performs functionality similar to conventional operating systems. More specifically, operating system 115 controls the resources of computer system 300 through conventional techniques and interfaces the instructions of application 17 with processing element 320 as necessary to enable application 17 to properly run.

Processing element 320 communicates with and drives the other elements within computer system 300 via a local interface 330, which may comprise one or more buses. Furthermore, an input device 340, for example a keyboard or a pointer device, can be used to input data from a user of computer system 300, and an output device 350, for example a display device or a printer, can be used to output data to the user. A disk storage device 360, such as a magnetic disk, can be connected to local interface 330 for data transfers therewith.

A host interface 370, for example a peripheral component interconnect, an IDE interface, a Small Computer System Interface (SCSI), or another peripheral interface, may be interconnected with local interface 330 and facilitates coupling of peripheral devices with interface 330. Host interface 370 is typically implemented as a socket, or expansion slot, and associated circuitry disposed on a backplane, e.g., a motherboard, of system 300 and provides a communication coupling or interconnection between a peripheral device 390 coupled with host interface 370 and processing element 320. An adapter 30, e.g., a daughter card, may be coupled with host interface 370 and facilitates communications between system 300 devices and peripheral device 390. Alternatively, adapter 30 may be implemented as circuitry and an interface disposed directly on the system 300 motherboard.

Memory device 310 stores one or more applications 17 that may be implemented as one or more computer-readable instruction set(s) executable by processing element 320. Application 17 may be maintained on non-volatile storage device 360 and fetched therefrom for loading into memory device 310 and retrieved therefrom by processing element 320.

Periodically, application 17 is required to communicate with a system device, e.g., peripheral device 390. In accordance with embodiments of the invention, application 17 may issue I/O request(s) formatted in accordance with an API that is not present on system 300. The I/O request may reference a data structure 130, e.g., an SRB, formatted in accordance with an application programming interface and that includes fields, e.g., structure members, that respectively define parameters of the I/O request. In a particular embodiment, client 17 issues ASPI-formatted I/O request 225 that is received by translation layer 100 that, in turn, derives or otherwise generates I/O request 235 according to the received ASPI-formatted I/O request 225. Member values of SRB 130 referenced by an argument of issued I/O request 225 are parsed from SRB 130. An SRB 131 formatted in accordance with adapter interface layer 110 is generated from the member values parsed from SRB 130 referenced by I/O request 225. Generation of SRB 131 may include allocation of a suitable memory space of memory device 310 and assignment of parsed member values to fields or members of SRB 131. Generated I/O request 235 is compatible with adapter interface layer 110 of O/S 115. Execution of I/O request 235 is then performed by adapter interface layer 110 by submitting one or more device commands 245 in accordance with I/O request 235 to peripheral device 390 via host interface 370.

In a similar manner, a return data set 255 generated by peripheral device 390 may be translated by translation layer 100. Return data set 255 is received by translation layer 100 from adapter interface layer 110 in an adapter interface layer format, e.g., in an SPT format. Application 17, however, is adapted to request and receive data according to an API format. Accordingly, translation layer 100 translates the adapter interface layer-formatted return data set 255 into an application programming interface-formatted return data set 265 expected by application 17, e.g., an ASPI-formatted return data set.

Translation layer 100 is preferably implemented as an instruction set(s), or program, of computer-readable logic. The instruction set is preferably maintained on any one of various conventional computer-readable mediums. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium now known or later developed, including (a non-exhaustive list): an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). It should be understood that the described techniques for generating an adapter interface layer-compliant I/O request are exemplary only and other techniques for implementing translation layer 100 may be suitably substituted for those described. For example, translation layer 100 may generate an I/O request formatted in accordance with the adapter interface layer by translating a received I/O request formatted according to an API not supported by O/S 115 by any one of various techniques. For example, an I/O request received by translation layer 100 may be used as an index to a database and for retrieval of an adapter interface layer-formatted I/O request therefrom that is subsequently submitted to adapter interface layer 110. Alternatively, one or more operands of a received I/O requests may be parsed therefrom and included within one or more operand fields of a generic adapter interface layer-formatted I/O request.

What is claimed is:

1. A computer-readable medium having stored thereon an instruction set to be executed, the instruction set, when executed by a processor, causes the processor to perform a computer method of:
receiving an input/output request formatted in accordance with an application programming interface;
generating an input/output request formatted in accordance with an adapter interface layer; and
submitting the generated input/output request to the adapter interface layer.

2. The computer-readable medium according to claim 1, wherein generating an input/output request further comprises:
parsing one or more field values from a data structure referenced by the received input/output request; and
inserting the parsed field values into respective fields of a data structure formatted in accordance with the adapter interface layer.

3. The computer-readable medium according to claim 2, wherein parsing one or more field values further comprises parsing one or more member values of a request block data structure formatted according to the application programming interface, and inserting the parsed field values further comprises assigning the parsed member values to members of a request block data structure formatted according to the adapter interface layer.

4. The computer-readable medium according to claim 1, wherein generating an input/output request formatted according to an adapter interface layer further comprises generating the input/output request formatted according to a pass-through interface of an operating system, and submitting the generated input/output request to the adapter interface layer further comprises submitting the generated input/output request to the pass-through interface.

5. The computer-readable medium according to claim 1, wherein the instruction set, when executed by the processor, further causes the processor to perform the computer method of identifying a command type of the received input/output request, and generating the input/output request further comprises generating the input/output request having a command type corresponding to the identified command type.

6. The computer-readable medium according to claim 5, wherein identifying a command type of the received input/output request further comprises parsing a command type from a field of a data structure referenced by the received input/output request, and generating the input/output request further comprises assigning a control code corresponding to the identified command type to an argument of the generated input/output request.

7. The computer-readable medium according to claim 1, wherein submitting the generated input/output request further comprises conveying the generated input/output request to a host adapter.

8. The computer-readable medium according to claim 7, wherein conveying the generated input/output request to a host adapter further comprises conveying the generated input/output request to a small computer system interface host adapter.

9. The computer-readable medium according to claim 1, wherein the instruction set, when executed by the processor, further causes the processor to perform the computer method of:
receiving a return data set formatted in accordance with the adapter interface layer; and
translating the return data set into a format compatible with the application programming interface.

10. The computer-readable medium according to claim 9, wherein the translated return data set is conveyed to a client application that generated the received input/output request.

11. A method for processing an input/output request in a computer system, comprising:
receiving, by a translation layer comprising a set of computer-readable instructions, an input/output request formatted in accordance with an application programming interface;
generating, by the translation layer, an input/output request in a format compatible with an adapter interface layer of an operating system; and
submitting the generated input/output request to the adapter interface layer.

12. The method according to claim 11, further comprising conveying, by the adapter interface layer, the generated input/output request to a host adapter.

13. The method according to claim 11, further comprising receiving, by the adapter interface layer, a return data set formatted in accordance with the adapter interface layer.

14. The method according to claim 13, further comprising:
conveying, by the adapter interface layer, the return data set to the translation layer; and
translating, by the translation layer, the return data set into a format compatible with the application programming interface.

15. The method according to claim 14, further comprising conveying the translated return data set to an application that originated the received input/output request.

16. A computer system for processing an input/output request, comprising:
a processing element;
a host adapter; and
a local interface communicatively coupling the processing element and the host adapter, the processing element operable to execute a set of computer-readable instructions operable to receive an input/output request formatted in accordance with an application programming interface and generate an input/output request formatted in accordance with an adapter interface layer of an operating system, the generated input/output request dependent upon the received input/output request, the processing element operable to submit the generated input/output request to the adapter interface layer.

17. The system according to claim 16, wherein the adapter interface layer conveys the generated input/output request to the host adapter.

18. The system according to claim 16, further comprising a peripheral device communicatively coupled with the local interface via the host adapter.

19. The system according to claim 18, wherein the peripheral device provides a return data set formatted in accordance with the adapter interface layer to the host adapter in response to receipt of the generated input/output request.

20. The system according to claim 16, wherein the adapter interface layer is operable to receive a return data set formatted in accordance with the adapter interface layer from the host adapter in response to processing of the generated input/output request, the adapter interface layer submitting the return data set to a translation layer.

21. The system according to claim 20, wherein the translation layer translates the return data set into a format compatible with the application programming interface.

22. The system according to claim 16, further comprising an application operable to generate the received input/output request, the application operable to receive a return data set formatted in accordance with the application programming interface.
